(19) United States
(12) Patent Application Publication
(10) Pub. No.: US 2025/0239658 A1
(43) Pub. Date: Jul. 24, 2025

(54) BATTERY

(71) Applicant: TOYOTA JIDOSHA KABUSHIKI KAISHA, Toyota-shi (JP)

(72) Inventor: Keiichi MINAMI, Tagata-gun (JP)

(73) Assignee: TOYOTA JIDOSHA KABUSHIKI KAISHA, Toyota-shi (JP)

(21) Appl. No.: 18/976,612

(22) Filed: Dec. 11, 2024

(30) Foreign Application Priority Data
Jan. 24, 2024 (JP) 2024-008704

(51) Int. Cl. H01M 10/42; H01M 4/62; H01M 10/0525; H01M 10/0562; H01M 10/0585

(52) U.S. Cl. CPC H01M 10/4235; H01M 4/62; H01M 10/0525; H01M 10/0562; H01M 10/0585; H01M 2300/0068

(57) ABSTRACT

A battery has a positive electrode active material layer, a negative electrode active material layer, and an electrolyte layer, arranged between the positive electrode active material layer and the negative electrode active material layer. And at least one of the positive electrode active material layer, the negative electrode active material layer, and the electrolyte layer contains a Li—Al halide-based molten salt, the Li—Al halide-based molten salt contains a first salt as a main component and a second salt as an added component. The first salt is a Li—Al halide salt at least containing LiAlCl₄, and the second salt is an ionic liquid.

### CROSS-REFERENCE TO RELATED APPLICATION

This application claims priority to Japanese Patent Application No. 2024-008704 filed on Jan. 24, 2024, incorporated herein by reference in its entirety.

### BACKGROUND

### 1. Technical Field

The present disclosure relates to a battery.

### 2. Description of Related Art

Batteries have been being actively developed in recent years. For example, in the automotive industries, batteries used for a battery electric vehicle (BEV), a plug-in hybrid electric vehicle (PHEV), or a hybrid electric vehicle (HEV) are being developed. Moreover, components and materials used for such batteries are being developed.

For example, Japanese Unexamined Patent Application Publication (Translation of PCT application) No. 2019-521475 discloses a battery including: a first polymer electrolyte layer including an aliphatic dinitrile compound, a lithium salt, and a lithium ion-conductive polymer; and a second polymer electrolyte layer including an ionic liquid, a lithium salt, and a lithium ion-conductive polymer. Moreover, Japanese Unexamined Patent Application Publication No. 2023-074634 discloses that a negative electrode active material layer in an all-solid-state battery contains a molten salt. Moreover, Japanese Unexamined Patent Application Publication No. 2019-114531 discloses a liquid electrolyte composition for a lithium-metal secondary battery and discloses that the liquid electrolyte composition may contain LiAlCl₄.

### SUMMARY

In view of improving battery performance, it is desired to improve an ion conductivity and to reduce a battery resistance. It is being investigated to use, as an electrolyte in a battery, a Li—Al halide salt such as LiAlCl₄. In this regard, since the Li—Al halide salt tends to be low in ion conductivity, the battery resistance tends to be large in the battery in which the Li—Al halide salt is used as the electrolyte.

The present disclosure is devised in view of the aforementioned circumstances and provides a battery in which the battery resistance is reduced.

There is provided a battery according to a first aspect of the present disclosure, including:
a positive electrode active material layer;
a negative electrode active material layer; and
an electrolyte layer arranged between the positive electrode active material layer and the negative electrode active material layer, wherein:
at least one of the positive electrode active material layer, the negative electrode active material layer, and the electrolyte layer contains a Li—Al halide-based molten salt;
the Li—Al halide-based molten salt contains a first salt as a main component and a second salt as an added component;
the first salt is a Li—Al halide salt at least including LiAlCl₄; and
the second salt is an ionic liquid.

According to the first aspect of the present disclosure, the ratio of the first salt in the Li—Al halide-based molten salt may be not less than 50 mol % and not more than 95 mol %.

According to the first aspect of the present disclosure, the ratio of the second salt in the Li—Al halide-based molten salt may be not less than 10 mol % and not more than 30 mol %.

According to the first aspect of the present disclosure, the first salt may include LiAlCl₄ and LiAlI₄, and the ratio of LiAlCl₄ in the first salt may be not less than 20 mol % and not more than 60 mol %.

According to the first aspect of the present disclosure, the second salt may contain, as a cation component, at least one of a sulfonium-based cation, a pyrrolidinium-based cation, a pyridinium-based cation, an ammonium-based cation, and a metal ion.

According to the first aspect of the present disclosure, the cation component may be at least one of methyldiethylsulfonium, triethylsulfonium, N-methyl-N-methoxymethylpyrrolidinium, N-methyl-N-propylpyrrolidinium, and 1-propyl-3-methylpyridinium.

According to the first aspect of the present disclosure, the second salt may contain, as an anion component, at least one of a sulfonylamide-based anion, a sulfuric acid-based anion, and a halogen ion.

According to the first aspect of the present disclosure, the anion component may be at least one of bis(trifluoromethanesulfonyl)amide, bis(fluorosulfonyl)amide, and fluorosulfonyl(trifluoromethanesulfonylamide).

According to the first aspect of the present disclosure, a melting point of the Li—Al halide-based molten salt may be not less than 10° C. and not more than 70° C.

According to the first aspect of the present disclosure, an ion conductivity of the Li—Al halide-based molten salt at 25° C. may be not less than 4.9×10⁻⁵ S/cm.

According to the first aspect of the present disclosure, an ion conductivity of the Li—Al halide-based molten salt at 25° C. may be not more than 3.4×10⁻³ S/cm.

According to the first aspect of the present disclosure, the negative electrode active material layer may contain the Li—Al halide-based molten salt.

According to the first aspect of the present disclosure, the battery may be a solid-state battery.

In the present disclosure, an effect of being capable of providing a battery in which the resistance is reduced is obtained.

### BRIEF DESCRIPTION OF THE DRAWINGS

Features, advantages, and technical and industrial significance of exemplary embodiments will be described below with reference to the accompanying drawings, in which like signs denote like elements, and wherein:

FIG. 1 is a schematic sectional view exemplarily showing a battery in the present disclosure.

### DETAILED DESCRIPTION OF EMBODIMENTS

Hereafter, a battery in the present disclosure will be described in detail.

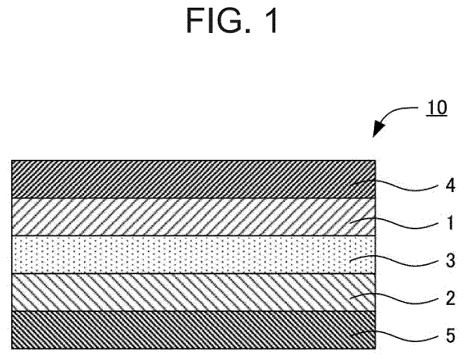

FIG. 1 is a schematic sectional view exemplarily showing the battery in the present disclosure. Notably, FIG. 1 schematically shows the battery in the present disclosure, and the measurements and the shapes of individual portions are properly exaggerated for easy understanding. A battery 10 shown in FIG. 1 has a positive electrode active material layer 1, a negative electrode active material layer 2, and an electrolyte layer 3 arranged between the positive electrode active material layer 1 and the negative electrode active material layer 2. In particular, in the battery 10 in the present disclosure, at least one of the positive electrode active material layer 1, the negative electrode active material layer 2, and the electrolyte layer 3 contains a Li—Al halide-based molten salt. Moreover, the Li—Al halide-based molten salt contains a first salt as a main component and a second salt as an added component, the first salt is a Li—Al halide salt at least including LiAlCl₄, and the second salt is an ionic liquid.

In the battery in the present disclosure, since at least one of the positive electrode active material layer, the negative electrode active material layer, and the electrolyte layer contains a predetermined Li—Al halide-based molten salt, the battery resistance is reduced.

It is being investigated that a Li—Al halide salt is used as an electrolyte in the battery. Meanwhile, the Li—Al halide salt tends to be relatively low in ion conductivity. It is inferred that this is because the interaction between Li cations and Al halide anions is strong and diffusion of Li is disturbed.

In contrast, since the Li—Al halide-based molten salt contained by the battery in the present disclosure has, as the main component, the first salt which is the Li—Al halide salt at least containing LiAlCl₄ and contains, as the added component, the second salt which is the ionic liquid, excellent ion conduction is attained. It is inferred that this is because LiAlCl₄ exhibits a relatively excellent ion conductivity among Li—Al halide salts, and moreover, the second salt can effectively restrain the interaction between Li cations and Al halide anions. As a result, the resistance of the battery containing the Li—Al halide-based molten salt is reduced.

Moreover, when the battery in the present disclosure is particularly a solid-state battery, the following advantages are also obtained. First, in the solid-state battery, there is a case where electrode layers such as a negative electrode active material layer expand and contract during charge and discharge and cracks arise. The cracks disconnect an ion conduction path and an electron conduction path, which causes concern that the battery resistance increases after repetition of charge and discharge. In this regard, since the Li—Al halide-based molten salt in the present disclosure has a relatively low melting point, the molten salt having fluidity can excellently fill cracks even when the cracks arise in the electrode layers. As a result, the solid-state battery containing the Li—Al halide-based molten salt restrains increase in battery resistance caused by disconnection of an ion conduction path and an electron conduction path and has excellent cycle characteristics.

### 1. Li—Al Halide-Based Molten Salt

The Li—Al halide-based molten salt in the present disclosure contains the first salt as the main component and the second salt as the added component. Here, the Li—Al halide-based molten salt in the present disclosure is typically contained as an electrolyte in the battery.

### (1) First Salt

The first salt is the Li—Al halide salt at least including LiAlCl₄. The first salt may only include LiAlCl₄ or may also include another compound (another salt). In other words, the first salt may be a salt composed of two kinds or more of salts. Moreover, the first salt may be a eutectic salt.

In the first salt, the ratio of LiAlCl₄ is, for example, not less than 10 mol %, may be not less than 20 mol %, may be not less than 30 mol %, or may be not less than 40 mol %. On the other hand, the ratio of LiAlCl₄ may be 100 mol % or may be less than 100 mol %. Moreover, the ratio of LiAlCl₄ may be not more than 90 mol %, may be not more than 80 mol %, may be not more than 70 mol %, may be not more than 60 mol %, or may be not more than 50 mol %.

Examples of the salt other than LiAlCl₄ include LiAlX₄ (X is any of F, Br, and I). One kind of salt other than LiAlCl₄ may be employed, or two kinds or more of salts other than LiAlCl₄ may be employed. Among those, LiAlI₄ may be employed.

The Li—Al halide-based molten salt contains the first salt as the main component. The “main component” means a component included in a ratio not less than 50 mol % in the Li—Al halide-based molten salt. The ratio of the first salt may be not less than 60 mol % or may be not less than 70 mol %. On the other hand, the ratio of the first salt is, for example, not more than 95 mol %, may be not more than 90 mol %, or may be not more than 30 80 mol %.

### (2) Second Salt

The second salt is the ionic liquid. The ionic liquid is a liquid-like salt having a cation component and an anion component, and means a salt that is liquid, for example, at or below 100° C. The ionic liquid may be a monocation-type ionic liquid having one cation structure, or may be a dication-type ionic liquid having two cation structures. Moreover, in the dication-type ionic liquid, the two cation structures may be identical or may be different. Notably, the second salt in the present disclosure does not usually correspond to the Li—Al halide salt.

Examples of the cation component include sulfonium-based cations such as methyldiethylsulfonium (S₁₂₂) and tricthylsulfonium (S₂₂₂), pyrrolidinium-based cations such as N-methyl-N-methoxymethylpyrrolidinium (P₁₍₁₀₁₎) and N-methyl-N-propylpyrrolidinium (P₁₃), pyridinium-based cations such as 1-propyl-3-methylpyridinium (1Pr-3Me-Py), ammonium-based cations such as tetrahexylammonium (THA), and metal ions such as a lithium ion. Notably, the “sulfonium-based” is used for a cation having a sulfonium group (R¹(R²)(R³)S⁺, where each of R¹ to R³ is a hydrogen or an organic group). Likewise, the “pyrrolidinium-based”, the “pyridinium-based”, and the “ammonium-based” are used for cations having a pyrrolidinium group, a pyridinium group, and an ammonium group, respectively. The second salt may contain one kind of cation, or may contain two kinds or more of cations.

Among the cation components above, the sulfonium-based cations, the pyrrolidinium-based cations, and the pyridinium-based cations may be employed. This is because they have large molecular weights and are bulky. This is because, when the second salt contains the bulky cation component, it is inferred that the interaction between Li and Al halide anions in the first salt can be made weak and it is inferred that the Li—Al halide-based molten salt that is more excellent in ion conductivity can be obtained.

Examples of the anion component include sulfonylamide-based anions such as bis(trifluoromethanesulfonyl)amide (TFSA), bis(fluorosulfonyl)amide (FSA), and fluorosulfonyl(trifluoromethanesulfonylamide) (FTA), sulfuric acid-based anions such as a hydrogensulfate ion, and halogen ions such as a chloride ion. Moreover, examples of the anion component also include a boron fluoride anion, a phosphorus fluoride ion, and trifluoromethanesulfonate. The second salt may contain one kind of anion component or may contain two kinds or more of anion components.

As the anion component, the sulfonylamide-based anions may be employed. This is because they have large molecular weights and are bulky. It is inferred that the bulky anion component can make the interaction between Li and Al halide anions in the first salt weak.

The second salt may be one kind of salt or may be a salt constituted of two kinds or more of salts.

The Li—Al halide-based molten salt contains the second salt (ionic liquid) as the added component. The “added component” means a component contained in the Li—Al halide-based molten salt in a lower ratio than that of the first salt as the main component.

The ratio of the second salt in the Li—Al halide-based molten salt is, for example, not less than 5 mol %, may be not less than 10 mol %, may be not less than 15 mol %, or may be not less than 20 mol %. On the other hand, the ratio of the second salt is, for example, not more than 40 mol %, may be not more than 35 mol %, may be not more than 30 mol %, or may be not more than 25 mol %.

Moreover, in the Li—Al halide-based molten salt, the ratio of the second salt relative to the first salt is, for example, not less than 5 mol % and not more than 45 mol %.

### (3) Li—Al Halide-Based Molten Salt

A melting point of the Li—Al halide-based molten salt is, for example, 100° C., may be not more than 80° C., may be not more than 70° C., may be not more than 60° C., or may be not more than 50° C. On the other hand, the melting point is, for example, not less than 10° C., may be not less than 20° C., may be not less than 30° C., or may be not less than 40° C. The melting point can be obtained, for example, by differential scanning calorimetry (DSC measurement).

An ion conductivity of the Li—Al halide-based molten salt (ion conductivity at 25° C.) is not specially limited, and it may be high. The ion conductivity is, for example, not less than 4.5×10⁻⁵ S/cm, may be not less than 4.9×10⁻⁵ S/cm, may be not less than 1.0×10⁻⁴ S/cm, may be not less than 3.0×10⁻⁴ S/cm, or may be not less than 5.0×10⁻⁴ S/cm. On the other hand, the ion conductivity is, for example, not more than 4.0×10⁻³ S/cm, may be not more than 3.4×10⁻³ S/cm, may be not more than 3.0×10⁻³ S/cm, may be not more than 2.0×10⁻³ S/cm, or may be not more than 1.5×10⁻³ S/cm. The ion conductivity can be obtained, for example, by an AC impedance method.

In the battery, the Li—Al halide-based molten salt is contained in at least one of the positive electrode active material layer, the negative electrode active material layer, and the electrolyte layer. The Li—Al halide-based molten salt may be contained only in the positive electrode active material layer, may be contained only in the negative electrode active material layer, or may be contained only in the electrolyte layer. Otherwise, the Li—Al halide-based molten salt may be contained in any two of the positive electrode active material layer, the negative electrode active material layer, and the electrolyte layer, or may be contained in all the three of those. Particularly in the battery in the present disclosure, the Li—Al halide-based molten salt may be contained in the negative electrode active material layer. Here, in the positive electrode active material layer, the negative electrode active material layer, and the electrolyte layer, the Li—Al halide-based molten salt may be used together with another electrolyte. The other electrolyte is mentioned later.

Moreover, the Li—Al halide-based molten salt can be prepared by a method described for Examples.

### 2. Positive Electrode Active Material Layer

The positive electrode active material layer at least contains a positive electrode active material.

Examples of the positive electrode active material include oxide active materials. Examples of the oxide active materials include layered rock salt-type active materials such as LiNi_{1/3}Co_{1/3}Mn_{1/3}O₂ and LiNi_{0.8}Co_{0.15}Al_{0.05}O₂, spinel-type active materials such as LiMn₂O₄, and olivine-type active materials such as LiFePO₄. Moreover, for the positive electrode active material, sulfur (S) may be used.

A shape of the positive electrode active material is particle-like, for example. An average particle size (D₅₀) of the positive electrode active material is, for example, not less than 0.5 μm and not more than 50 μm. The average particle size (D₅₀) means a volume cumulative particle diameter measured by a laser diffraction scattering-type particle size distribution measurement apparatus. The ratio of the positive electrode active material in the positive electrode active material layer is, for example, not less than 50 weight % and not more than 80 weight %.

The positive electrode active material layer may contain at least one of an electrolyte, a conductive material, and a binder as needed. The positive electrode active material layer may contain or does not have to contain, as the electrolyte, the Li—Al halide-based molten salt mentioned above. Moreover, the positive electrode active material layer may contain, as the electrolyte, only the Li—Al halide-based molten salt, or may contain the Li—Al halide-based molten salt and another electrolyte. The electrolyte is described in “4. Electrolyte Layer”.

Examples of the conductive material include carbon materials. Examples of the carbon materials include particle-like carbon materials such as acetylene black (AB) and Ketjen black (KB), and fibrous carbon materials such as carbon fibers, carbon nanotubes (CNTs), and carbon nanofibers (CNFs). The ratio of the conductive material in the positive electrode active material layer is, for example, not less than 0.01 weight % and not more than 10 weight %.

Examples of the binder include rubber-based binders such as butadiene rubber (BR), acrylate-butadiene rubber (ABR), and styrene-butadiene rubber (SBR), and fluorine-containing binders such as polyvinylidene fluoride (PVDF) and polytetrafluoroethylene (PTFE). The ratio of the binder in the positive electrode active material layer is, for example, not less than 0.5 weight % and not more than 10 weight %.

A thickness of the positive electrode active material layer is not specially limited and is, for example, not less than 0.1 μm and not more than 1000 μm.

### 3. Negative Electrode Active Material Layer

The negative electrode active material layer at least contains a negative electrode active material.

Examples of the negative electrode active material include a Si-based active material. The Si-based active material is an active material that contains a Si element. Examples of the Si-based active material include a Si simple substance, a Si alloy, and a Si oxide. The Si alloy may contain the Si element as a main component. The ratio of the Si element in the Si alloy is, for example, not less than 50 mol %, may be not less than 70 mol %, or may be not less than 90 mol %. On the other hand, the ratio of the Si element in the Si alloy is, for example, not more than 99 mol %. Examples of the Si alloy include a Si—Al-based alloy, a Si—Sn-based alloy, a Si—In-based alloy, a Si—Ag-based alloy, a Si—Pb-based alloy, a Si—Sb-based alloy, a Si—Bi-based alloy, a Si—Mg-based alloy, a Si—Ca-based alloy, a Si—Ge-based alloy, a Si—Pb-based alloy, and the like. The Si alloy may be a two-component alloy or may be a multicomponent alloy of three or more components. Examples of the Si oxide include SiO.

Moreover, the Si-based active material may have a diamond-type crystal phase, may have a type I clathrate crystal phase, or may have a type II clathrate crystal phase. In the crystal phase of the type I or type II clathrate, a polyhedron (cage) including pentagons or hexagons is formed with a plurality of Si elements. Since this polyhedron has a space inside that can make a clathrate of metal ion(s) such as Li ion(s), a volume change during charge and discharge can be restrained. Moreover, the Si-based active material may have voids inside its primary particles. The voids can restrain the volume change of the active material, and cracks of the negative electrode active material layer can be restrained. A porosity is not specially limited and is, for example, not less than 4% and not more than 40%. That the primary particles have voids and the porosity can be examined by scanning electron microscope (SEM) observation.

The negative electrode active material layer may contain at least one of an electrolyte, a conductive material, and a binder as needed. The negative electrode active material layer may contain or does not have to contain, as the electrolyte, the Li—Al halide-based molten salt mentioned above, and the former may be employed. Moreover, the negative electrode active material layer may contain, as the electrolyte, only the Li—Al halide-based molten salt, or may contain the Li—Al halide-based molten salt and another electrolyte. The electrolyte, the Li—Al halide-based molten salt, the conductive material, and the binder are like those described in “2. Positive Electrode Active Material Layer”.

A thickness of the negative electrode active material layer is not specially limited and is, for example, not less than 0.1 μm and not more than 1000 μm.

### 4. Electrolyte Layer

The electrolyte layer at least contains an electrolyte. Moreover, the electrolyte layer may contain or does not have to contain, as the electrolyte, the Li—Al halide-based molten salt mentioned above. Moreover, the electrolyte layer may contain, as the electrolyte, only the Li—Al halide-based molten salt, or may contain the Li—Al halide-based molten salt and another electrolyte.

In the electrolyte layer, the ratio of the Li—Al halide-based molten salt relative to the total electrolyte may be 100 weight %, or may be less than 100 weight %. In the latter case, the ratio is, for example, not less than 10 weight % and not more than 80 weight %.

The electrolyte layer may contain an electrolyte other than the Li—Al halide-based molten salt. Examples of the electrolyte include a solid electrolyte. Examples of the solid electrolyte include inorganic solid electrolytes such as a sulfide solid electrolyte, an oxide solid electrolyte, and a halide solid electrolyte. The sulfide solid electrolyte may contain sulfur (S) as a main component of anion elements. The oxide solid electrolyte may contain oxygen (O) as a main component of anion elements. The halide solid electrolyte may contain halogen as a main component of anions. Among these, the sulfide solid electrolyte may be employed.

The sulfide solid electrolyte may contain a Li element, an M element (M is at least one of P, Sn, Al, Zn, In, Ge, Si, Sb, Ga, and Bi), and a S element. Moreover, the sulfide solid electrolyte may contain a halogen element such as F, Cl, Br, and I. Moreover, in the sulfide solid electrolyte, O element(s) may be substituted for one or some of S elements.

The sulfide solid electrolyte may be a glass-based (amorphous) sulfide solid electrolyte, may be a glass ceramic sulfide solid electrolyte, or may be a crystalline sulfide solid electrolyte. Examples of a crystal phase included in the sulfide solid electrolyte include an LGPS-type crystal phase, a Thio-LISICON-type crystal phase, and an argyrodite-type crystal phase.

Examples of the sulfide solid electrolyte include Li₂S—P₂S₅, Li₂S—P₂S₅—LiI, Li₂S—P₂S₅—GeS₂, Li₂S—P₂S₅—Li₂O, Li₂S—P₂S₅—Li₂O—LiI, Li₂S—P₂S₅—LiI—LiBr, Li₂S—SiS₂, Li₂S—SiS₂—LiI, Li₂S—SiS₂—LiBr, Li₂S—SiS₂—LiCI, Li₂S—SiS₂—B₂S₃—LiI, Li₂S—SiS₂—P₂S₅—LiI, Li₂S—B₂S₃, Li₂S—P₂S₅—ZₘSₙ (where m and n are positive numbers, and Z is any of Ge, Zn, and Ga), Li₂S—GeS₂, Li₂S—SiS₂—Li₃PO₄, Li₂S—SiS₂—LiₓMO_{y} (where x and y are positive numbers, and M is any of P, Si, Ge, B, Al, Ga, and In).

Moreover, the electrolyte layer may contain a binder as needed. The binder is like that described in “2. Positive Electrode Active Material Layer”.

A thickness of the electrolyte layer is not specially limited and is, for example, not less than 0.1 μm and not more than 1000 μm.

### 5. Other Configurations

As shown in FIG. 1, the battery 10 in the present disclosure typically has a positive electrode current collector body 4 that collects electrons of the positive electrode active material layer 1, and a negative electrode current collector body 5 that collects electrons of the negative electrode active material layer 2. Example of a material of the positive electrode current collector body include SUS, aluminum, nickel, iron, titanium, and carbon. Examples of a material of the negative electrode current collector body include SUS, copper, nickel, and carbon.

Moreover, the battery in the present disclosure may include an exterior body that houses the aforementioned members. Examples of the exterior body include a laminate-type exterior body and a case-type exterior body. Moreover, the battery in the present disclosure may include a restraining jig that exerts confining pressure in the thickness direction on the aforementioned members. As the restricting jig, a known jig can be used. The confining pressure is, for example, not less than 0.1 MPa and not more than 50 MPa, or may be not less than 1 MPa and not more than 20 MPa.

### 6. Battery

The battery in the present disclosure is typically a lithium ion secondary battery. Moreover, the battery in the present disclosure may be a liquid battery or may be a solid-state battery. Here, when the electrolyte layer in the battery contains an electrolyte that is solid at ambient temperature (for example, an inorganic solid electrolyte), the battery can be regarded as a solid-state battery. Moreover, the solid-state battery may be a semi-solid-state battery or may be an all-solid-state battery. When the electrolyte layer in the battery contain an electrolyte that is solid at ambient temperature and an electrolyte that is liquid at ambient temperature (for example, a molten salt), the battery can be regarded as the semi-solid-state battery. Moreover, when the electrolyte layer in the battery contains only an electrolyte that is solid at ambient temperature, the battery can be regarded as the all-solid-state battery.

Examples of applications of the battery include power supplies for vehicles such as a hybrid electric vehicle (HEV), a plug-in hybrid electric vehicle (PHEV), a battery electric vehicle (BEV), a gasoline automobile, and a diesel automobile. Moreover, the battery in the present disclosure may be used for power supplies for movable bodies (for example, a railroad, a ship, and an airplane) other than vehicles, or may be used for power supplies for electric appliances such as an information processing apparatus.

Notably, the present disclosure is not limited to the aforementioned embodiment. The aforementioned embodiment is an exemplary illustration, and anything that has a substantially equivalent configuration to that based on the technical concept disclosed in the claims in the present disclosure and attains the similar effect(s) is included in the technical scope in the present disclosure.

### Example 1

### Preparation of First Salt

Totally 10 g of LiCl and AlCl₃ were weighed as raw materials, and 100 g of heptane was weighed. These were input to a ball mill manufactured by Fritsch (Size: 500 mL; Balls used: ZrO₂) and were ground at 300 rpm for 20 h. This afforded LiAlCl₄. LiAlI₄ was obtained by the similar method using LiI and AlI₃ as raw materials. LiAlCl₄ and LiAlI₄ were mixed to have a molar ratio of 20:80. This afforded a first salt (Li—Al halide eutectic salt: 20LiAlCl₄-80LiAlI₄).

### Preparation of Molten Salt

As a second salt, an ionic liquid (S₁₂₂TFSA) composed of methyldiethylsulfonium (S₁₂₂) as the cation component and bis(trifluoromethanesulfonyl)amide (TFSA) as the anion component was prepared. The first salt and the second salt above were mixed in a screw bottle. Then, they were heated and stirred up to 160° C. using a hot stirrer thereby to afford a compound (molten salt) homogeneous in the molten state. Notably, the first salt and the second salt were added in respective amounts such that the ratio of the second salt in the molten salt was 30 mol %. Evaluations mentioned later were performed with the obtained molten salt being as a sample.

### Example 2 to Example 21

Each molten salt was obtained as with Example 1 except that at least one of the type of the first salt, the type of the second salt, and the ratio of the second salt was changed as presented in Table 1.

### Comparative Example 1 to Comparative Example 6

For each, not using the second salt, the salt presented in Table 1 was prepared as a sample.

### Comparative Example 7 to Comparative Example 9

The salt (LiAlI₄) that did not contain LiAlCl₄, and the second salt presented in Table 1 were prepared to prepare a molten salt (sample) by the similar method to that for Example 1 with the ratio presented in Table 1.

### Evaluations

### Measurement of Melting Point

The melting point was obtained by DSC measurement. Specifically, each sample was contained in an Al pan and sealed. The temperature of this was raised from −100° C. to 100° C. at 5° C./min using a very low temperature DSC measurement apparatus (DSC-200 F3) manufactured by NETZSCH. From the obtained profile, the inflection point in an endothermic change showing the melting was acquired as the melting point. Meanwhile, for a sample (high melting point sample) for which an inflection point in an endothermic change was not observed until 100° C., using a measurement apparatus (DSC-60) manufactured by Shimadzu Corporation, the temperature was raised from room temperature to 200° C. at 5° C./min. From the obtained profile, the inflection point in an endothermic change showing the melting was acquired as the melting point. Table 1 presents the results.

### Measurement of Ion Conductivity

The ion conductivity was obtained by impedance measurement. Specifically, first, each sample was molten into a liquid state. With the sample in the liquid state, a battery evaluating batch cell (SB1A) manufactured by EC FRONTIER CO., LTD. was filled to perform impedance measurement at 25° C. From the resistance value thus obtained and the shape factor, the ion conductivity was calculated. Table 1 presents the results.

TABLE 1

| | | Second Salt | | Melting | Ion |
|---|---|---|---|---|---|
| | | | Ratio | Point | Conductivity |
| | First Salt | Type | (mol %) | (° C.) | (S/cm) |
| Comparative | LiAlI₄ | — | — | 210 | 1.0 × 10⁻⁵ |
| Example 1 | | | | | |
| Comparative | 20LiAlCl₄-80LiAlI₄ | — | — | 137 | 7.5 × 10⁻⁶ |
| Example 2 | | | | | |
| Comparative | 40LiAlCl₄-60LiAlI₄ | — | — | 72 | 7.4 × 10⁻⁶ |
| Example 3 | | | | | |
| Comparative | 60LiAlCl₄-40LiAlI₄ | — | — | 73 | 3.7 × 10⁻⁶ |
| Example 4 | | | | | |
| Comparative | 80LiAlCl₄-20LiAlI₄ | — | — | 70 | 3.4 × 10⁻⁷ |
| Example 5 | | | | | |
| Comparative | LiAlCl4 | — | — | 140 | 8.8 × 10⁻⁸ |
| Example 6 | | | | | |
| Comparative | LiAlI₄ | P₁₍₁₀₁₎TFSA | 30 | 123 | 1.1 × 10⁻⁶ |
| Example 7 | | | | | |
| Comparative | LiAlI₄ | P₁₍₁₀₁₎TFSA | 40 | 82 | 3.8 × 10⁻⁶ |
| Example 8 | | | | | |
| Comparative | LiAlI₄ | P₁₃TFSA | 30 | 78 | 2.3 × 10⁻⁸ |
| Example 9 | | | | | |
| Example 1 | 20LiAlCl₄-80LiAlI₄ | S₁₂₂TFSA | 30 | 10 | 4.0 × 10⁻⁴ |
| Example 2 | 20LiAlCl₄-80LiAlI₄ | 1Pr-3Me-PyTFSA | 30 | Supercooling | 1.4 × 10⁻⁴ |
| Example 3 | 40LiAlCl₄-60LiAlI₄ | S₂₂₂TFSA | 10 | 41 | 1.8 × 10⁻⁴ |
| Example 4 | 40LiAlCl₄-60LiAlI₄ | S₁₂₂TFSA | 30 | Supercooling | 7.3 × 10⁻⁴ |
| Example 5 | 40LiAlCl₄-60LiAlI₄ | P₁₃TFSA | 30 | 4 | 3.3 × 10⁻⁴ |
| Example 6 | 40LiAlCl₄-60LiAlI₄ | 1Pr-3Me-PyTFSA | 30 | Supercooling | 4.9 × 10⁻⁴ |
| Example 7 | 60LiAlCl₄-40LiAlI₄ | LiTFSA | 10 | 57 | 7.6 × 10⁻⁵ |
| Example 8 | 60LiAlCl₄-40LiAlI₄ | LiFTA | 10 | 45 | 4.5 × 10⁻⁴ |
| Example 9 | 60LiAlCl₄-40LiAlI₄ | LiFSA | 10 | 58 | 1.1 × 10⁻⁴ |
| Example 10 | 60LiAlCl₄-40LiAlI₄ | THACI | 10 | 53 | 1.2 × 10⁻⁴ |
| Example 11 | 60LiAlCl₄-40LiAlI₄ | THAHSO₄ | 10 | 29 | 4.9 × 10⁻⁵ |
| Example 12 | 60LiAlCl₄-40LiAlI₄ | S₁₂₂TFSA | 10 | 52 | 2.3 × 10⁻⁴ |
| Example 13 | 60LiAlCl₄-40LiAlI₄ | S₂₂₂TFSA | 10 | 45 | 7.6 × 10⁻⁵ |
| Example 14 | 60LiAlCl₄-40LiAlI₄ | S₁₂₂TFSA | 20 | 30 | 9.8 × 10⁻⁴ |
| Example 15 | 60LiAlCl₄-40LiAlI₄ | S₂₂₂TFSA | 20 | 28 | 1.2 × 10⁻³ |
| Example 16 | 60LiAlCl₄-40LiAlI₄ | S₁₂₂TFSA | 30 | 24 | 1.3 × 10⁻³ |
| Example 17 | 60LiAlCl₄-40LiAlI₄ | P₁₃TFSA | 30 | 16 | 3.6 × 10⁻⁴ |
| Example 18 | 60LiAlCl₄-40LiAlI₄ | P₁₍₁₀₁₎TFSA | 30 | 30 | 1.5 × 10⁻⁴ |
| Example 19 | 60LiAlCl₄-40LiAlI₄ | 1Pr-3Me-PyTFSA | 30 | Supercooling | 1.1 × 10⁻³ |
| Example 20 | LiAlCl₄ | S₁₂₂TFSA | 20 | 16 | 3.4 × 10⁻³ |
| Example 21 | LiAlCl₄ | P₁₍₁₀₁₎TFSA | 30 | 21 | 1.5 × 10⁻³ |

As presented in Table 1, the Li—Al halide-based molten salts in the present disclosure had ion conductivities not less than 4.9×10⁻⁵ S/cm and exhibited more excellent ion conductivities than in the comparative examples. This indirectly showed that, in the battery containing the Li—Al halide-based molten salt in the present disclosure, the battery resistance was reduced. Notably, according to Table 1, the samples of Example 2, Example 4, Example 6, and Example 19 were in the state of supercooling in the DSC measurement, and it is inferred that their melting points were near room temperature.

What is claimed is:

1. A battery comprising:
a positive electrode active material layer;
a negative electrode active material layer; and
an electrolyte layer arranged between the positive electrode active material layer and the negative electrode active material layer, wherein:
at least one of the positive electrode active material layer, the negative electrode active material layer, and the electrolyte layer contains a Li—Al halide-based molten salt;
the Li—Al halide-based molten salt contains a first salt as a main component and a second salt as an added component;
the first salt is a Li—Al halide salt at least including LiAlCl₄; and
the second salt is an ionic liquid.

2. The battery according to claim 1, wherein a ratio of the first salt in the Li—Al halide-based molten salt is not less than 50 mol % and not more than 95 mol %.

3. The battery according to claim 1, wherein a ratio of the second salt in the Li—Al halide-based molten salt is not less than 10 mol % and not more than 30 mol %.

4. The battery according to claim 1, wherein:
the first salt includes LiAlCl₄ and LiAlI₄; and
a ratio of LiAlCl₄ in the first salt is not less than 20 mol % and not more than 60 mol %.

5. The battery according to claim 1, wherein the second salt contains, as a cation component, at least one of a sulfonium-based cation, a pyrrolidinium-based cation, a pyridinium-based cation, an ammonium-based cation, and a metal ion.

6. The battery according to claim 5, wherein the cation component is at least one of methyldiethylsulfonium, triethylsulfonium, N-methyl-N-methoxymethylpyrrolidinium, N-methyl-N-propylpyrrolidinium, and 1-propyl-3-methylpyridinium.

7. The battery according to claim 1, wherein the second salt contains, as an anion component, at least one of a sulfonylamide-based anion, a sulfuric acid-based anion, and a halogen ion.

8. The battery according to claim 7, wherein the anion component is at least one of bis(trifluoromethanesulfonyl)amide, bis(fluorosulfonyl)amide, and fluorosulfonyl(trifluoromethanesulfonylamide).

9. The battery according to claim 1, wherein a melting point of the Li—Al halide-based molten salt is not less than 10° C. and not more than 70° C.

10. The battery according to claim 1, wherein an ion conductivity of the Li—Al halide-based molten salt at 25° C. is not less than 4.9×10⁻⁵ S/cm.

11. The battery according to claim 1, wherein an ion conductivity of the Li—Al halide-based molten salt at 25° C. is not more than 3.4×10⁻³ S/cm.

12. The battery according to claim 1, wherein the negative electrode active material layer contains the Li—Al halide-based molten salt.

13. The battery according to claim 1, wherein the battery is a solid-state battery.
